(19) United States
(12) Patent Application Publication
(10) Pub. No.: US 2006/0016482 A1
(43) Pub. Date: Jan. 26, 2006

(54) Device for preventing backflow in a cooling system

(75) Inventors: Jessica Rose Berens, Rochester, MN (US); Cary Michael Huettner, Rochester, MN (US); Michael Scott Good, Fountain, MN (US); Maurice Francis Holahan, Lake City, MN (US)

Correspondence Address: IBM Corporation;Intellectual Property Law Dept., 3605 Highway 52 North, Rochester, MN, 55901-7829, US

(73) Assignee: International Business Machines Corporation, Armonk, NY (US)

(21) Appl. No.: 10/897,334

(22) Filed: Jul. 22, 2004

(51) Int. Cl. F16K 15/16

(52) U.S. Cl. 137/512.15

(57) ABSTRACT

A novel check valve for an exhaust device is formed from a thin flexible plate. A plurality of flaps is formed in the thin flexible plate. The flaps are arranged in a vertical manner to form at least one column of flaps. A stopper is coupled to a back side of the thin flexible plate. The stopper prevents the plurality of flaps from moving towards the stopper.

### BACKGROUND OF THE INVENTION

1. Field of the Invention

The present invention relates generally to a device for preventing backflow in a cooling system, and more particularly, to a fan check valve having a plurality of flaps, wherein the flaps control airflow in a single direction.

2. Background Information

Enclosed electronic systems, which run on continuous operation, generally employ a system for cooling the enclosure. Most cooling systems typically employ some type of fan or blower. Many cooling systems employ redundant fans that are arranged in parallel. This arrangement is used to guard against catastrophic loss of cooling flow in the event of a single fan device failure. One problem with this type fan configuration is that when one fan fails, the pressure difference across the surviving fan pushes air backwards through the failed fan. This reduces the delivered flow rate that would otherwise be available from the surviving fan(s), a significant fraction of the overall fan output.

To prevent back flow, the normal practice is to add a flap-type device on the exhaust side of the fans. Prior flapper designs include swinging door flaps, multiple slat vanes, and helical vanes for tubeaxial fans. However, prior art designs consume valuable packaging space and may fail to operate properly in situations where the exhaust flow must turn at any angle to the axially discharging flow, as would be encountered for example in the tightly confined chassis space within a server rack drawer. Under these conditions, transverse flow from surviving fan(s) can prevent the flaps from properly sealing a failed fan if the flow traversing the failed fan re-opens the flaps in shear.

Therefore, it would be desirable to provide a device that prevents backflow in a cooling system. The device must overcome problems associated with prior art designs.

### SUMMARY OF THE INVENTION

It is, therefore, a principle object of this invention to provide a device for preventing backflow in a cooling system.

It is another object of the invention to provide a device for preventing backflow in a cooling system that solves the above mentioned problems.

These and other objects of the present invention are accomplished by the device for preventing backflow in a cooling system disclosed herein.

In an exemplary aspect of this invention, a check valve for an exhaust device is formed from a thin flexible plate. A plurality of flaps is formed in the thin flexible plate. The flaps are arranged in a vertical manner to form at least one column of flaps. One or more stoppers are coupled to a back side of the thin flexible plate. The stopper prevents the plurality of flaps from moving towards the stopper when the pressure reverses in fan fail mode. The backstop function of the stopper may be provided by a bar member, a separate metal or plastic grid attached to the fan, or integral to the chassis, either of which additionally serves as a safety finger guard.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1A is a back view of an exhaust fan valve of the present invention.

FIG. 1B is a front view of the exhaust fan valve of FIG. 1A installed on a cooling fan.

FIG. 2 is an exploded view of FIG. 1B.

FIG. 3 is an elevated perspective view of the exhaust fan valve of FIG. 1A installed on a cooling system with the flaps aligning their opening angle with the preferred flow turning direction.

### DETAILED DESCRIPTION OF THE PREFERRED EMBODIMENTS

The invention will now be described in more detail by way of example with reference to the embodiments shown in the accompanying figures. It should be kept in mind that the following described embodiments are only presented by way of example and should not be construed as limiting the inventive concept to any particular physical configuration.

Further, if used and unless otherwise stated, the terms “upper,” “lower,” “front,” “back,” “over,” “under,” and similar such terms are not to be construed as limiting the invention to a particular orientation. Instead, these terms are used only on a relative basis.

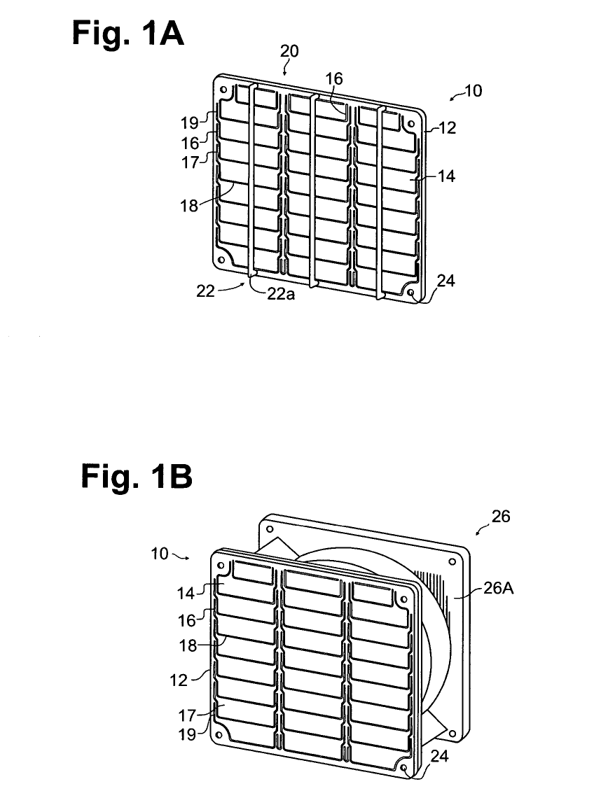

With reference now to the figures, and in particular with reference to FIG. 1A, there is depicted a rear view of the fan valve 10 of the present invention. The fan valve 10 is formed of a thin flat flexible plate 12. The plate 12 is generally some type of plastic or film material. A plurality of flaps 14 are formed in the plate 12. The flaps 14 are formed so as to allow air flow to move freely out of the fan 26 (FIG. 1B) and turn at an angle, normal to the axis of discharging flow. The flaps 14 are cut in a “U” shaped fashion such that each flap 14 will have a pair of side edges 16 and a bottom edge 18. The flaps 14 are generally slightly tapered. Thus, the side edges 16 on a bottom section 17 are closer together than the side edges 16 on a top section 19 of the flaps 14.

The flaps 14 may be formed in a plurality of different configurations. In accordance with one embodiment, the flaps 14 are formed in a column 20. The fan valve 10 may have one or more columns 20. In the embodiment depicted in FIG. 1A, three columns 20 are shown. However, this should not be seen as to limit the scope of the present invention. The flaps 14 are formed in a vertical manner. In this embodiment, the bottom section 17 of a flap 14 will contact a top section 19 of a flap 14 immediately below. The above embodiment allows one to make a cost effective design formed out of a single piece of material.

The flaps 14 are designed to align their opening angle with the preferred flow turning direction. In normal operation, each flap 14 independently self-aligns with the flow direction to minimize aerodynamic drag. Minimization of aerodynamic drag is a critical performance consideration, because excess drag requires higher fan speeds, higher acoustic levels, and generally reduces the overall availability of cooling flow. This self alignment is made possible by the tapered cut in each flap 14 wherein each flap's construction allows the connection to behave as a low-bending-force hinge. If the hinge is not thin enough, the flap will not properly align and the resulting angle of incidence with respect to oncoming flow will lead to high drag force and pressure losses which diminish the output of the fan. A higher degree of self-alignment is possible with the flexible material, as compared to fixed solid vane designs.

However, due to curvature of flowstreams over the span of the flap chord, a finite degree of non-alignment is present, which will induce a turning moment of the airstream in the direction of the flapper opening angle. The overall orientation of the flapper assembly thus also functions to turn the airflow in a preferential direction with respect to the initial discharge axis, similar to a set of airflow turning vanes formed by a cascade of flat plates.

The embodiment of the flaps 14 does not rely on the action of gravity for flap 14 closure and therefore may be operated in any direction with respect to gravity. This is a significant advantage over heavy pivoted solid flap designs which rely on gravity to assist closure.

One or more stoppers 22 will be coupled to the plate 12. The stoppers 22 are used to prevent each flap 14 from moving in a direction towards the fan 26. The backstop function of the stopper 22 may be provided by a bar member 22a, a separate metal or plastic grid attached to the fan, or integral to the chassis, either of which additionally serves as a safety finger guard, tab members, or any other mechanism designed to prevent the flaps 14 from moving in a direction towards the stopper 22.

In accordance with one embodiment of the present invention, the stopper 22 is a bar member 22a. Each column 20 of flaps 14 will have a bar member 22a which will run the length of the column 20. The bar 22a is used to prevent the flaps 14 from moving in a direction towards the bar member 22a. Thus, the flaps 14 can only move in a direction away from the bar 22a. Since the flaps 14 can only move away from the bar 22a, backflow through the fan valve 10 is prevented.

A plurality of holes 24 are formed on the plate 12. The holes 24 are used for mounting the fan valve 10 on a fan 26 (FIG. 1B). The holes 24 are generally formed around the outer perimeter of the plate 12. In the embodiment depicted in FIG. 1A, the holes 24 are formed in each corner of the plate 12. However, this should not be seen as to limit the scope of the present invention. It should also be noted that other means may be used to mount the fan valve 10 on a fan 26 (FIG. 1B). For example, an adhesive may be placed around the outer perimeter of the back side of the fan valve 10.

Referring now to FIG. 1B, the fan valve 10 is shown mounted on an exhaust device 26. The fan valve 10 may be coupled to any type of exhaust device 26 such as a fan or blower. The preferred embodiment exhaust device 26 has a low exhaust swirl component, which would encompass centrifugal blowers, radial blowers, or tubeaxial fans with flow-straightening discharge stators.

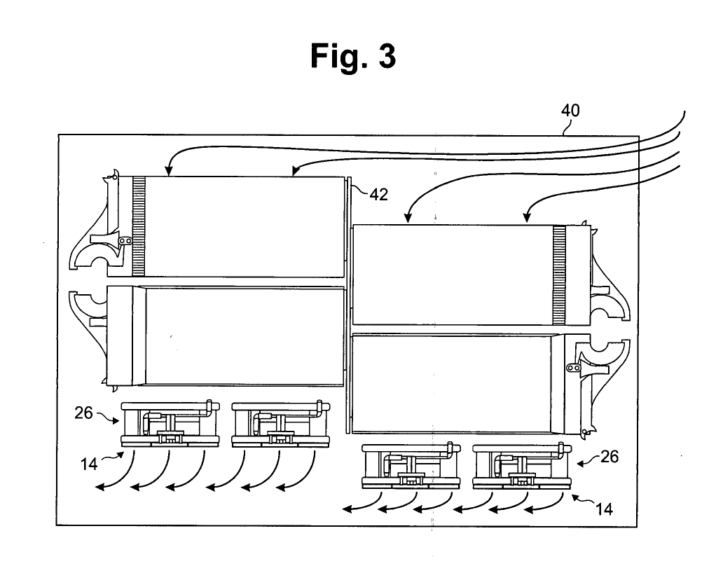

The fan valve 10 is mounted to the exhaust side 28 of the exhaust device 26. The exhaust device 26 is typically used in parallel with other exhaust devices 26 to circulate air and cool electrical components inside an enclosure 40 (FIG. 3).

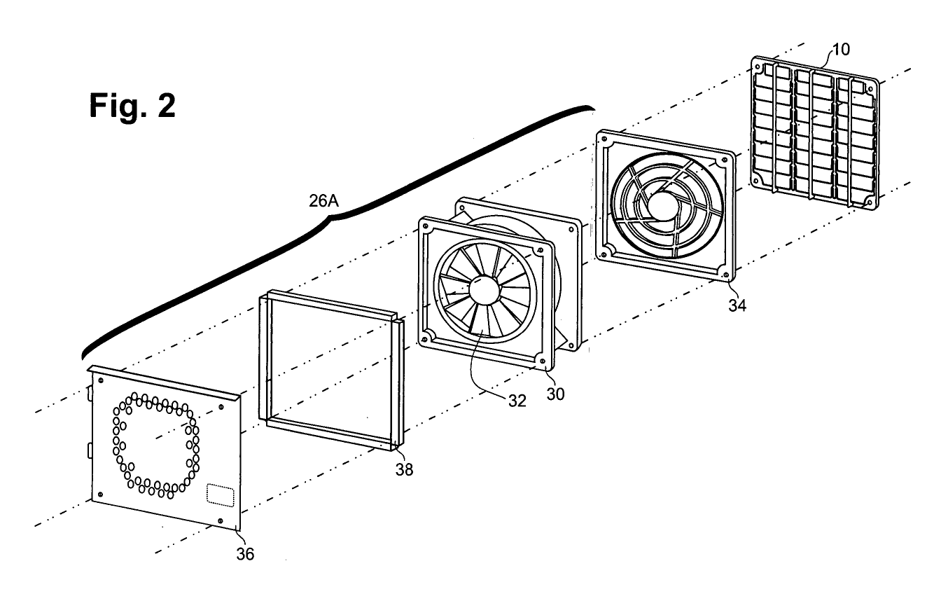

Referring now to FIG. 2, one embodiment of the exhaust device 26 is shown. In this embodiment, the exhaust device 26 is a fan 26A. The fan 26A comprises a fan motor 30 with an impeller 32, a grill or cover 34, a back plate 36, and an optional foam seal 38 between the fan motor 30 and back plate 36. As stated above, the fan valve 10 is mounted to the exhaust side 28 of the fan 26A.

As shown in FIG. 3, fans 26A are used to draw air through the enclosure 40. Since the enclosure 40 has a partition 42, fans 26A are placed on both sides of the partition 42. As stated above, the fan valve 10 is mounted to the exhaust side 28 of the fans 26A. The flaps 14 of the fan valve 10 will only move a direction away from the bar 22 and thus away from the fan 26A. Thus, in case any of the fans 26A fail, the fan valve 10 will prevent any back flow into the enclosure 40.

It should be understood, however, that the invention is not necessarily limited to the specific process, arrangement, materials and components shown and described above, but may be susceptible to numerous variations within the scope of the invention.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes and adaptations, and the same are intended to be comprehended within the meaning and range of equivalents of the appended claims.

What is claimed is:

1. A check valve for an exhaust device comprising:
a thin flexible plate to be coupled to an exhaust side of said exhaust device;
a plurality of flaps formed in said thin flexible plate, said flaps arranged in a vertical manner to form at least one column; and
at least one stopper coupled to a back side of said thin flexible plate, said stopper prevents said plurality of flaps from moving towards said stopper.

2. The check valve of claim 1 wherein said plurality of flaps are defined by a pair of side edges and a bottom edge, said pair of side edges being tapered so a bottom section of said pair of side edges are closer together than a top section of said pair of side edges.

3. The check valve of claim 2 wherein said plurality of flaps are formed in a vertical manner, said top section of each flap being in contact with said bottom section of an immediately preceding flap.

4. The check valve of claim 1 wherein said plurality of flaps are “U” shaped, a top section of a flap being in contact with a bottom section of an immediately preceding flap.

5. The check valve of claim 1 wherein said plurality of flaps are formed to align an opening angle with a preferred flow turning direction.

6. The check valve of claim 1 wherein said stopper is a bar member, said bar member running a length of said at least one column.

7. The check valve of claim 1 further comprising a plurality of holes formed around an outer perimeter of said thin flexible plate, said plurality of holes being used to couple said check valve to said exhaust device.

8. A check valve for an exhaust device comprising:
a thin flexible film member to be coupled to an exhaust side of said exhaust device;
a plurality of flaps formed in said thin flexible film member, said plurality of flaps arranged in a vertical manner to form a plurality of columns, said plurality of flaps are “U” shaped, a top section of a flap being in contact with a bottom section of an immediately preceding flap; and
a plurality of stoppers coupled to a back side of said thin flexible film member, said plurality of stoppers prevent said plurality of flaps from moving towards said plurality of stoppers.

9. The check valve of claim 8 wherein said plurality of flaps are defined by a pair of side edges and a bottom edge, said pair of side edges being tapered so a bottom section of said pair of side edges are closer together than a top section of said pair of side edges.

10. The check valve of claim 8 wherein said plurality of flaps are formed to align an opening angle with a preferred flow turning direction.

11. The check valve of claim 8 wherein said plurality of stoppers is a plurality of bar members wherein at least one bar member runs a length of each of said plurality of columns.

12. A method for manufacturing a check valve for an exhaust device, said method comprising:
providing a thin flexible plate;
forming a plurality of flaps in said thin flexible plate, said flaps arranged in a vertical manner to form at least one column; and
coupling at least one stopper to a back side of said thin flexible plate, said stopper prevents said plurality of flaps from moving towards said stopper.

13. The method of claim 12 wherein forming said flap further comprises forming said plurality of flaps wherein each of said plurality of flaps has a pair of side edges and a bottom edge, said pair of side edges being tapered so a bottom section of said pair of side edges are closer together than a top section of said pair of side edges.

14. The method of claim 12 wherein forming said plurality of flaps further comprises forming said plurality of flaps in a “U” shape, a top section of a flap being in contact with a bottom section of an immediately preceding flap.

15. The method of claim 12 wherein forming said plurality of flaps further comprises forming said plurality of flaps to align an opening angle of each flap with a preferred flow turning direction.

16. The method of claim 12 further comprising forming a plurality of holes around an outer perimeter of said thin flexible plate, said plurality of holes being used to couple said check valve to said fan.
